(19) United States
(12) Patent Application Publication
(10) Pub. No.: US 2017/0045782 A1
(43) Pub. Date: Feb. 16, 2017

(54) LIQUID CRYSTAL DISPLAY AND METHOD OF MANUFACTURING THE SAME

(71) Applicant: Samsung Display Co., Ltd., Yongin city (KR)

(72) Inventor: Young Bong CHO, Seongnam-si (KR)

(21) Appl. No.: 15/062,724

(22) Filed: Mar. 7, 2016

(30) Foreign Application Priority Data
Aug. 12, 2015 (KR) 10-2015-0113900

(51) Int. Cl. G02F 1/1337; G02F 1/1339; G02F 1/1335

(52) U.S. Cl. CPC G02F 1/133707; G02F 1/133512; G02F 1/13394; G02F 1/1339; G02F 1/133514; G02F 2001/13398

(57) ABSTRACT

Provided are a liquid crystal display and a method of manufacturing a liquid crystal display. According to an aspect of the present inventive concept, there is provided a liquid crystal display which includes a first substrate which includes a display area and a non-display area disposed outside the display area, a second substrate which is located opposite the first substrate, a light-blocking pattern which is disposed on the non-display area, and a plurality of alignment layer barrier patterns which protrude from the black matrix toward the second substrate and are formed integrally with the light-blocking pattern in the non-display area.

This application claims priority to Korean Patent Application No. 10-2015-0113900 filed on Aug. 12, 2015 in the Korean Intellectual Property Office, the disclosure of which is incorporated herein by reference in its entirety.

### BACKGROUND

1. Field

The present inventive concept relates to a liquid crystal display (LCD) and a method of manufacturing the same.

2. Description of the Related Art

With the development of multimedia, the importance of display devices is increasing. Accordingly, various types of display devices such as liquid crystal displays (LCDs) and organic light-emitting displays (OLEDs) are being used.

In particular, LCDs are one of the most widely used types of flat panel displays. Generally, an LCD includes a pair of substrates having field generating electrodes, such as pixel electrodes and a common electrode, and a liquid crystal layer interposed between the two substrates. In an LCD, voltages are applied to field generating electrodes to generate an electric field in a liquid crystal layer. Accordingly, the alignment of liquid crystal molecules of the liquid crystal layer is determined, and polarization of incident light is controlled. As a result, a desired image is displayed on the LCD.

Generally, an LCD includes a display area in which an image is displayed and a non-display area in which various signal lines are disposed to enable the display area to display an image. To implement an LCD having a narrow bezel, the non-display area is being gradually reduced. In this case, however, the placement of various wirings and interference from the display area are becoming an issue due to the narrow space of the non-display area.

### SUMMARY

Aspects of the present inventive concept provide a liquid crystal display (LCD) having a narrow bezel.

Aspects of the present inventive concept also provide an LCD having improved adhesion performance between an upper substrate and a lower substrate.

Aspects of the present inventive concept also provide a method of manufacturing an LCD having a narrow bezel.

Aspects of the present inventive concept also provide a method of manufacturing an LCD having improved adhesion performance between an upper substrate and a lower substrate.

However, aspects of the present inventive concept are not restricted to the one set forth herein. The above and other aspects of the present inventive concept will become more apparent to one of ordinary skill in the art to which the present inventive concept pertains by referencing the detailed description of the present inventive concept given below.

According to an aspect of the present inventive concept, there is provided a liquid crystal display which includes a first substrate which includes a display area and a non-display area disposed outside the display area, a second substrate which is located opposite the first substrate, a light-blocking pattern which is disposed on the non-display area, and a plurality of alignment layer barrier patterns which protrude from the black matrix toward the second substrate and are formed integrally with the light blocking pattern in the non-display area. An upper end of one alignment layer barrier pattern and an upper end of another adjacent alignment layer barrier pattern may be separated from each other.

According to another aspect of the present inventive concept, there is provided a method of manufacturing a liquid crystal display which includes preparing a first substrate which includes a gate insulating layer, a semiconductor pattern layer disposed on the gate insulating layer, a data line disposed on the semiconductor pattern layer, a passivation layer disposed on the data line and a light-blocking layer disposed on the passivation layer and in which a display area and a non-display area are defined, forming a light-blocking pattern and a plurality of alignment layer barrier patterns which protrude from the light-blocking pattern in the non-display area by patterning the light-blocking layer, and forming a first alignment layer in the display area.

### BRIEF DESCRIPTION OF THE DRAWINGS

The above and other aspects and features of the present inventive concept will become more apparent by describing in detail exemplary embodiments thereof with reference to the attached drawings, in which:

FIG. 1 is a plan view of a liquid crystal display (LCD) according to an embodiment of the present inventive concept;

FIG. 2 is an enlarged view of an area ‘A’ of FIG. 1;

FIG. 3 is a cross-sectional view taken along the line I-I′ of FIG. 2;

FIG. 4 is an enlarged view of an area ‘B’ of FIG. 1;

FIG. 5 is a cross-sectional view taken along the line II-II′ of FIG. 4;

FIG. 6 is a partial enlarged view of an area ‘B’ of FIG. 1 according to another embodiment of the present inventive concept;

FIG. 7 is a cross-sectional view of an LCD according to another embodiment of the present inventive concept;

FIGS. 8, 9 and 10 are cross-sectional views illustrating a method of manufacturing an LCD according to an embodiment of the present inventive concept; and

FIGS. 11 and 12 are cross-sectional views illustrating a method of manufacturing an LCD according to another embodiment of the present inventive concept.

### DETAILED DESCRIPTION

The aspects and features of the present inventive concept and methods for achieving the aspects and features will be apparent by referring to the embodiments to be described in detail with reference to the accompanying drawings. However, the present inventive concept is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the inventive concept, and the present inventive concept is only defined within the scope of the appended claims.

The term “on” that is used to designate that an element is on another element or located on a different layer or a layer includes both a case where an element is located directly on another element or a layer and a case where an element is located on another element via another layer or still another element. In the entire description of the present inventive concept, the same drawing reference numerals are used for the same elements across various figures.

Although the terms “first, second, and so forth” are used to describe diverse constituent elements, such constituent elements are not limited by the terms. The terms are used only to discriminate a constituent element from other constituent elements. Accordingly, in the following description, a first constituent element may be a second constituent element.

Hereinafter, embodiments of the present inventive concept will be described with reference to the attached drawings.

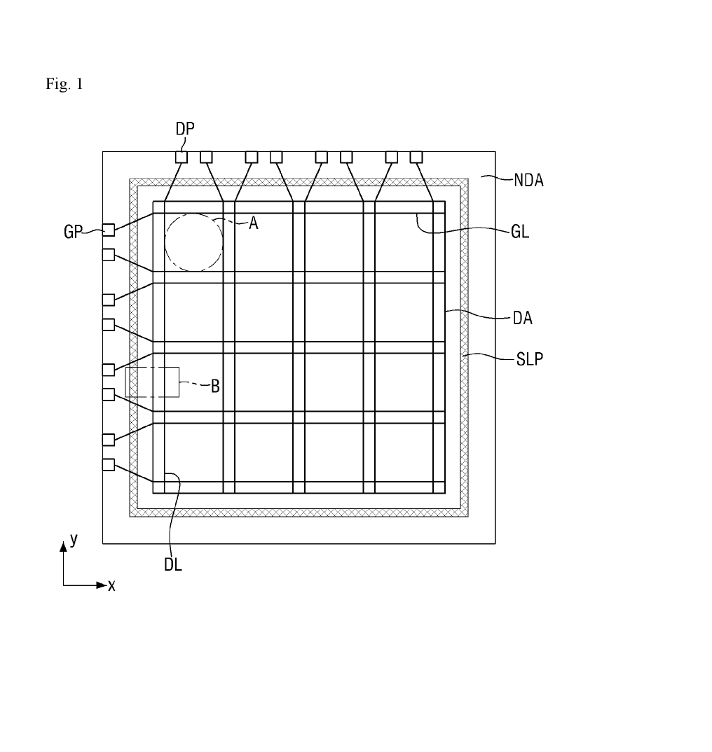

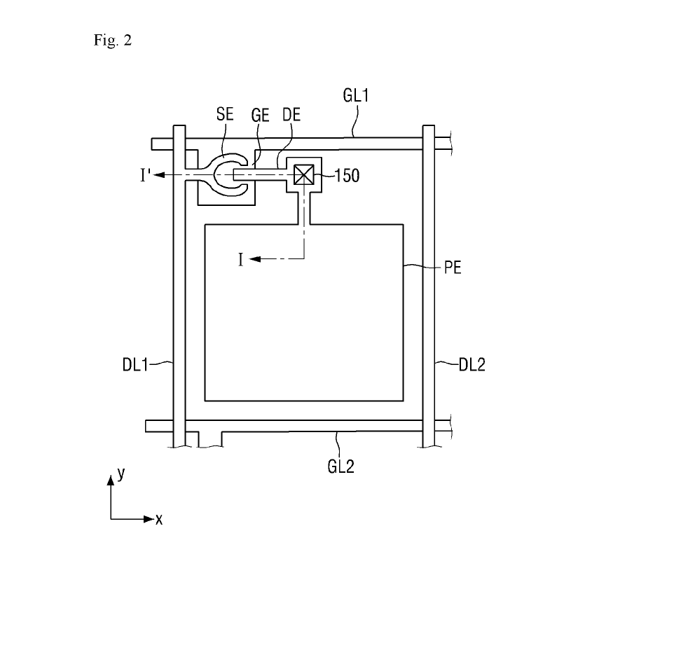

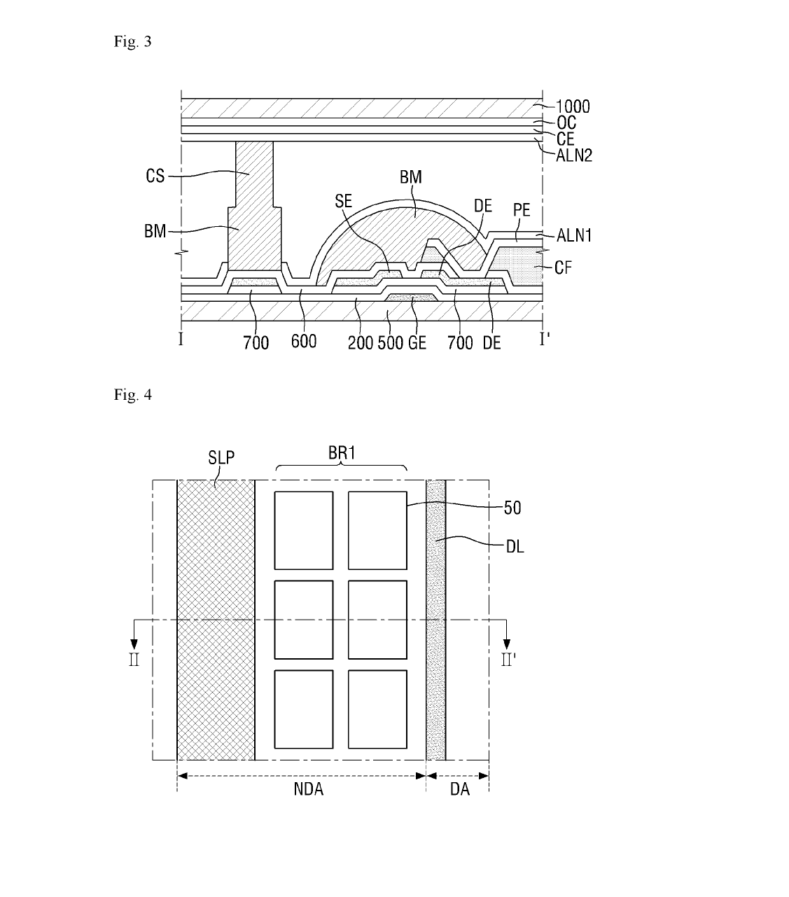

FIG. 1 is a plan view of a liquid crystal display (LCD) according to an embodiment of the present inventive concept. FIG. 2 is an enlarged view of an area ‘A’ of FIG. 1. FIG. 3 is a cross-sectional view taken along the line I-I′ of FIG. 2.

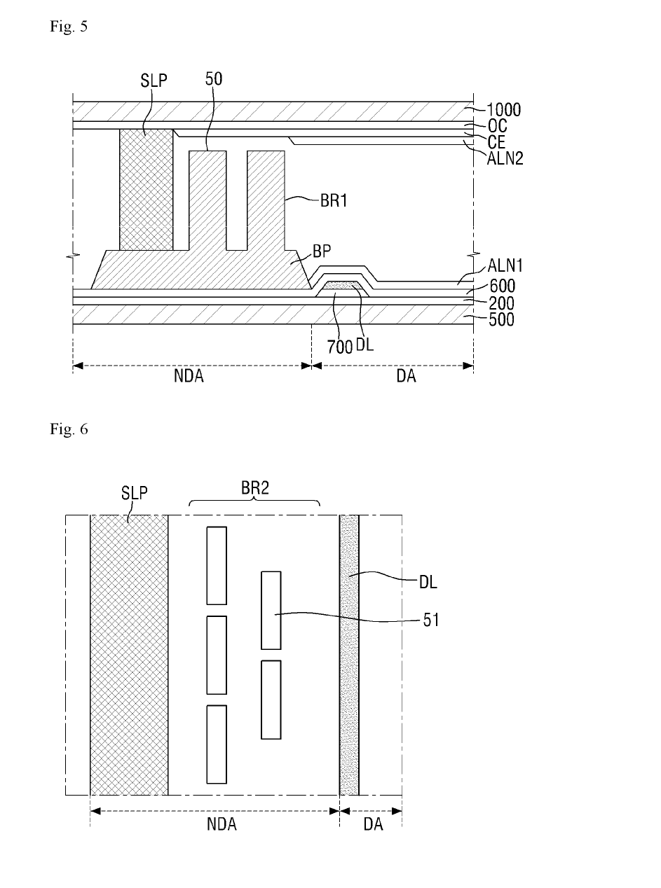

Referring to FIGS. 1 through 3, the LCD according to the current embodiment includes a first substrate 500 which includes a display area DA and a non-display area NDA disposed outside the display area DA, a second substrate 1000 which is located opposite the first substrate 500, a black matrix BM which is disposed on at least one side of the non-display area NDA, and a plurality of alignment layer barrier patterns BR1 (see FIGS. 4 and 5) which protrude from the black matrix BM toward the second substrate 1000 and are formed integrally with the black matrix BM.

The first substrate 500 may be made of a material having heat-resisting and light-transmitting properties. The first substrate 500 may be made of, but not limited to, transparent glass or plastic. The display area DA and the non-display area NDA are defined in the first substrate 500.

The display area DA is an area of a display device in which an image is displayed, and the non-display area NDA is an area in which various signal lines are disposed to enable the display area DA to display an image. The display area DA will now be described in greater detail with reference to FIGS. 2 and 3. The display area DA may include a plurality of pixel regions formed by intersection of a plurality of data lines DL and a plurality of gate lines GL. FIG. 2 is an enlarged view of one pixel in one of the pixel regions. The display area DA may include a plurality of pixels, each being substantially identical to the pixel of FIG. 2.

Referring to FIG. 2, a gate wiring (GL, GE) may be disposed on the first substrate 500. The gate wiring (GL, GE) may include a gate line GL which receives a driving signal, a gate electrode GE which protrudes from the gate line GL, and a gate pad (not illustrated) which is disposed on at least one end of the gate line GL.

The gate line GL may extend along a first direction. The first direction may be substantially the same as an x-axis direction of FIG. 2. The gate electrode GE may form three terminals of a thin-film transistor (TFT) together with a source electrode SE and a drain electrode DE which will be described later.

The gate wiring (GL, GE) may contain one or more of aluminum (Al)-based metal such as an aluminum alloy, silver (Ag)-based metal such as a silver alloy, copper (Cu)-based metal such as a copper alloy, molybdenum (Mo)-based metal such as a molybdenum alloy, chrome (Cr), titanium (Ti), and tantalum (Ta). However, the above materials are merely examples, and the material of the gate wiring (GL, GE) is not limited to the above materials. The gate wiring (GL, GE) can also be made of a metal or polymer material having the performance required to implement a desired display device.

The gate wiring (GL, GE) may have a single layer structure. However, the gate wiring (GL, GE) is not limited to the single layer structure and may also be a multilayer such as a double layer or a triple or more layer.

A gate insulating layer 200 may be disposed on the gate wiring (GL, GE). The gate insulating layer 200 may cover the gate wiring (GL, GE) and may be formed on the whole surface of the first substrate 500.

The gate insulating layer 200 may be made of any one material or a mixture of one or more materials selected from the group consisting of an inorganic insulating material such as silicon oxide (SiOx) or silicon nitride (SiNx) and an organic insulating material such as benzocyclobutene (BCB), an acrylic material or polyimide. However, the above materials are merely examples, and the material of the gate insulating layer 200 is not limited to the above materials.

A semiconductor pattern layer 700 may be disposed on the gate insulating layer 200.

The semiconductor pattern layer 700 may contain amorphous silicon or polycrystalline silicon. However, the material of the semiconductor pattern layer 700 is not limited to the above materials, and the semiconductor pattern layer 700 can also contain an oxide semiconductor.

The semiconductor layer 700 can have various shapes such as an island shape and a linear shape. When the semiconductor pattern layer 700 is linearly shaped, it may be located under the data line DL and extend onto the gate electrode GE.

In an exemplary embodiment, the semiconductor pattern layer 700 may be patterned in substantially the same shape as a data wiring (DL, SE, DE, 150), which will be described later, in areas excluding a channel region. In other words, the semiconductor pattern layer 700 may overlap the data wiring (DL, SE, DE, 150) in all areas excluding the channel region. The channel region may be disposed between the source electrode SE and the drain electrode DE which are located opposite each other. The channel region may electrically connect the source electrode SE and the drain electrode DE, and the specific shape of the channel region is not limited to a particular shape.

An ohmic contact layer (not illustrated) heavily doped with an n-type impurity may be disposed on the semiconductor pattern layer 700. The ohmic contact layer may overlap the whole or part of the semiconductor pattern layer 700. In an exemplary embodiment in which the semiconductor pattern layer 700 contains an oxide semiconductor, the ohmic contact layer can be omitted.

The data wiring (DL, SE, DE, 150) may be disposed on the semiconductor pattern layer 700. The data wiring (DL, SE, DE, 150) may include a data line DL which extends along a second direction, for example, a y-axis direction of FIG. 2 and intersects the gate line GL, the source electrode SE which branches off from the data line DL and extends onto the semiconductor pattern layer 700, the drain electrode DE which is separated from the source electrode SE and is disposed on the semiconductor pattern layer 700 to be opposite the source electrode SE with respect to the gate electrode GE or the channel region, and a drain electrode extension 150 which extends from the drain electrode DE to be electrically connected to a pixel electrode PE which will be described later. The drain electrode extension 150 may be relatively wider than the drain electrode DE. This makes it easier to electrically connect the drain electrode extension 150 to the pixel electrode PE.

The data wiring (DL, SE, DE, 150) may have a single layer structure or a multilayer structure composed of one or more of nickel (Ni), cobalt (Co), titanium (Ti), silver (Ag), copper (Cu), molybdenum (Mo), aluminum (Al), beryllium (Be), niobium (Nb), gold (Au), iron (Fe), selenium (Se), and tantalum (Ta). In addition, the data wiring (DL, SE, DE, 150) may be made of an alloy of any one of the above metals and one or more elements selected from the group consisting of titanium (Ti), zirconium (Zr), tungsten (W), tantalum (Ta), niobium (Nb), platinum (Pt), hafnium (Hf), oxygen (O), and nitrogen (N). However, the above materials are merely examples, and the material of the data wiring (DL, SE, DE, 150) is not limited to the above materials.

In FIG. 2, one TFT is disposed in one pixel. However, the present inventive concept is not limited thereto. That is, a plurality of TFTs can also be disposed in one pixel in another exemplary embodiment of the present inventive concept.

Referring to FIG. 3, a passivation layer 600 may be disposed on the data wiring (DL, SE, DE, 150) and the semiconductor pattern layer 700. The passivation layer 600 may contain an inorganic insulating material. For example, the passivation layer 600 may be made of silicon oxide, silicon nitride, silicon oxynitride, aluminum oxynitride, titanium oxynitride, zirconium oxynitride, hafnium oxynitride, tantalum oxynitride, or tungsten oxynitride. However, the above materials are merely examples, and the material of the passivation layer 600 is not limited to the above materials.

A contact hole which exposes the drain electrode extension 150 may be formed in the passivation layer 600.

A color filter CF may be formed on the passivation layer 600. The color filter CF may include one or more color filters which include a blue color filter, a green color filter, and a red color filter. In an exemplary embodiment, the blue color filter, the green color filter and the red color filter may have different heights.

A contact hole which exposes the drain electrode DE may be formed in the color filter CF. The contact hole formed in the color filter CF may overlap the contact hole formed in the passivation layer 600. Accordingly, the drain electrode DE may be exposed, and the pixel electrode PE which will be described later may be electrically connected to the exposed drain electrode DE.

The pixel electrode PE may be disposed on the color filter CF. The pixel electrode PE may be electrically connected to the drain electrode DE by the contact holes formed in the passivation layer 600 and the color filter CF.

In an exemplary embodiment, the pixel electrode PE may be made of a transparent conductor such as indium tin oxide (ITO) or indium zinc oxide (IZO) or a reflective conductor such as aluminum.

In FIG. 2, the pixel electrode PE is shaped like a flat plate. However, the shape of the pixel electrode PE is not limited to the flat plate. That is, in another exemplary embodiment, the pixel electrode PE may have one or more slits. In addition, in another exemplary embodiment, one or more pixel electrodes may be provided. In this case, different voltages may be applied to the pixel electrodes.

The black matrix BM may be disposed on the passivation layer 600. The black matrix BM may extend along the data line DL. A width of the black matrix BM may be substantially equal to or greater than that of the data line DL. In addition, the black matrix BM may cover the source electrode SE, the drain electrode DE, and the channel region. In other words, the black matrix BM may overlap the TFT and cover an area in which the TFT is formed.

The black matrix BM may block incident light. To this end, the black matrix BM may be made of photosensitive resin that contains a black pigment. However, the photosensitive resin is merely an example, and the material of the black matrix is not limited to the photosensitive resin. The black matrix BM can be made of any material having properties required to block incident light.

A column spacer CS may be formed on the black matrix BM which overlaps the data line DL. The column spacer CS may protrude from the black matrix BM toward the second substrate 1000. The column spacer CS may be formed integrally with the black matrix BM. In other words, the black matrix BM and the column spacer CS may be made of substantially the same material through the same process. That is, the LCD according to the current embodiment may be a black column spacer (BCS) LCD.

The column spacer CS may maintain a constant cell gap between the first substrate 500 and the second substrate 1000 which will be described later.

A first alignment layer ALN1 may be disposed on the first substrate 500 having a plurality of pixels. The first alignment layer ALN1 is designed to initially align a liquid crystal layer LC disposed between the first substrate 500 and the second substrate 1000. The first alignment layer ALN1 may contain a polymer material that undergoes one of decomposition, dimerization, and isomerization in response to light (e.g., ultraviolet (UV) light or laser light). In addition, the first alignment layer ALN1 may be made of a polymer polymerized with reactive mesogens.

An overcoat layer OC may be disposed on the second substrate 1000. The overcoat layer OC may be made of an organic or inorganic insulating material.

A common electrode CE may be formed on the overcoat layer OC. The common electrode CE may be an unpatterned plate-like electrode covering overall surface of the overcoat layer OC. However, the common electrode CE mays have a pattern according to another embodiment or the inventive concept. A common voltage may be applied to the common electrode CE, and the movement of liquid crystals disposed between the first substrate 500 and the second substrate 1000 may be controlled by an electric field formed between the common electrode CE and the pixel electrode PE.

A second alignment layer ALN2 may be disposed on the common electrode CE. The second alignment layer ALN2 is designed to initially align the liquid crystal layer LC disposed between the first substrate 500 and the second substrate 1000. The second alignment layer ALN2 may contain a polymer material that undergoes one of decomposition, dimerization, and isomerization in response to light (e.g., UV light or laser light). In addition, the second alignment layer ALN2 may be made of a polymer polymerized with reactive mesogens.

The non-display area NDA will now be described with reference to FIG. 1. Various wirings for driving the display area DA may be disposed in the non-display area NDA. Specifically, a plurality of data pads DP which are electrically connected to a data driver (not illustrated) and a plurality of data fan-out lines which connect the data lines DL of the display area DA and the data pads DP may be disposed in the non-display area DA.

In addition, a plurality of gate pads GP which are connected to a gate driver (not illustrated) may be disposed on a side of the non-display area NDA, and a plurality of gate fan-out lines which connect the gate lines GL of the display area DA and the gate pads GP may be disposed in the non-display area NDA.

A seal pattern SLP may be disposed in the non-display area NDA. The seal pattern SLP may bond the first substrate 500 and the second substrate 1000 together. The seal pattern SLP may be disposed in the non-display area NDA to surround the circumference of the display area DA. That is, in an exemplary embodiment in which the display area DA is shaped like a quadrilateral, the seal pattern SLP may surround four sides of the quadrilateral display area DA.

Elements disposed in the non-display area NDA will now be described in greater detail with reference to FIGS. 4 and 5.

FIG. 4 is an enlarged view of an area B′ of FIG. 1. FIG. 5 is a cross-sectional view taken along the line II-II′ of FIG. 4.

Referring to FIGS. 4 and 5, a light-blocking pattern BP may be disposed in the non-display area NDA. The light-blocking pattern BP may at least partially overlap the seal pattern SLP. The light-blocking pattern BP in the non-display area NDA may be made of substantially the same material as the black matrix BM in the display area DA. That is, in an exemplary embodiment, the black matrix BM of the display area DA and the light-blocking pattern BP of the non-display area NDA may be formed substantially simultaneously in the same process.

The light-blocking pattern BP may be formed on at least one side of the non-display area NDA. In an exemplary embodiment in which the display area DA is shaped like a quadrilateral, the light-blocking pattern BP may be disposed on any one or more of the four sides of the display area DA. That is, the light-blocking pattern BP may be disposed between an outermost data line DL of the display area DA and the seal pattern SLP of the non-display area NDA or between an outermost gate line GL of the display area DA and the seal pattern SLP of the non-display area NDA.

The alignment layer barrier patterns BR1 may be disposed on the light-blocking pattern BP. The alignment layer barrier patterns BR1 may protrude from the light-blocking pattern BP toward the second substrate 1000. That is, the alignment layer barrier patterns BR1 may be formed integrally with the light-blocking pattern BP. Therefore, the alignment layer barrier patterns BR1 may be made of substantially the same material and process as the light-blocking pattern BP. The alignment layer barrier patterns BR1 may be formed integrally with the light-blocking pattern BP in the same way that the black matrix BM and the column spacer CS are formed integrally with each other in the display area DA. In other words, the black matrix BM and the column spacer CS of the display area DA and the light-blocking pattern BP and the alignment layer barrier patterns BR1 of the non-display area NDA can be formed of the same material on the same plane using one mask, for example, by patterning one black light-blocking layer coated on the whole surface of the first substrate 500.

An upper end 50 of one alignment layer barrier pattern BR1 may be separated from an upper end 50 of another adjacent alignment layer barrier pattern BR1. In other words, lower ends of the alignment layer barrier patterns BR1 are integrally connected to the light-blocking pattern BP. However, the upper ends 50 of the alignment layer barrier patterns BR1 protruding from the light-blocking pattern BP may be separated from each other. In an example, the upper end 50 of one alignment layer barrier pattern BR1 may be shaped like a quadrilateral as illustrated in the plan view of FIG. 4. However, the shape of the alignment layer barrier pattern BR1 may have different configurations such as a circular shape, an oval shape and a quadrilateral shape with rounded corner.

In an example, the upper ends 50 of the alignment layer barrier patterns BR1 may be separated from each other and arranged in a matrix of m columns and n rows. In FIG. 4, the upper ends 50 of the alignment layer barrier patterns BR1 are arranged in a 2×n matrix, but the present inventive concept is not limited thereto. Here, m and n may be integers equal to or greater than two.

Referring to FIG. 5, the upper ends 50 of the alignment layer barrier patterns BR1 may be separated from a lower end of the second substrate 1000 by a predetermined gap. Specifically, the upper ends 50 of the alignment layer barrier patterns BR1 may be separated from an element (the common electrode CE in FIG. 5) disposed on a lowest end of the second substrate 1000 by a predetermined gap. When the upper ends 50 of the alignment layer barrier patterns BR1 are separated from the second substrate 1000 by a predetermined gap, liquid crystal molecules of the display area DA can move to the non-display area NDA, but the first alignment layer ALN1 of the display area DA cannot go over the alignment layer barrier patterns BR1. This configuration can prevent the leakage of light around the boundary of the display area DA and a reduction in the adhesive force of the seal pattern SLP due to the alignment layer on the alignment layer barrier patterns BR1.

Hereinafter, LCDs according to other embodiments of the present inventive concept will be described. In the following embodiments, elements substantially identical to those described above are indicated by like reference numerals, and a redundant description thereof will be omitted or given briefly.

FIG. 6 is a partial enlarged view of an area ‘B’ of FIG. 1 according to another embodiment of the present inventive concept.

Referring to FIG. 6, the LCD according to the current embodiment is different from the LCD according to the embodiment of FIG. 4 in that upper ends 51 of alignment layer barrier patterns BR2 are shaped like bars extending in a direction perpendicular to an x axis and that the upper ends 51 of the alignment layer barrier patterns BR2 disposed in a first column are arranged alternately with the upper ends 51 of the alignment layer barrier patterns BR2 disposed in a second column. In other word, the first column and the second column form a staggered type arrangement.

The upper ends 51 of the alignment layer barrier patterns BR2 may be shaped like bars and separated from each other. In addition, gaps between the upper ends 51 of the alignment layer barrier patterns BR2 disposed in the first column may be arranged alternately with gaps between the upper ends 51 of the alignment layer barrier patterns BR2 disposed in the second column. That is, the gaps between the upper ends 51 of the alignment layer barrier patterns BR2 disposed in the first column and the gaps between the upper ends 51 of the alignment layer barrier patterns BR2 disposed in the second column are not arranged along a positive x-axis direction. By alternately placing the upper ends 51 of the alignment layer barrier patterns BR2 as described above, it is possible to efficiently control the flow of a first alignment layer ALN1 of a display area DA. Accordingly, an alignment layer can be prevented from being formed on a seal pattern forming area of a non-display area NDA and degrading adhesive properties of the seal pattern SLP.

In FIG. 6, the alignment layer barrier patterns BR2 are arranged in two columns. However, the present inventive concept is not limited thereto, and the alignment layer barrier patterns BR2 can also be arranged in two or more columns.

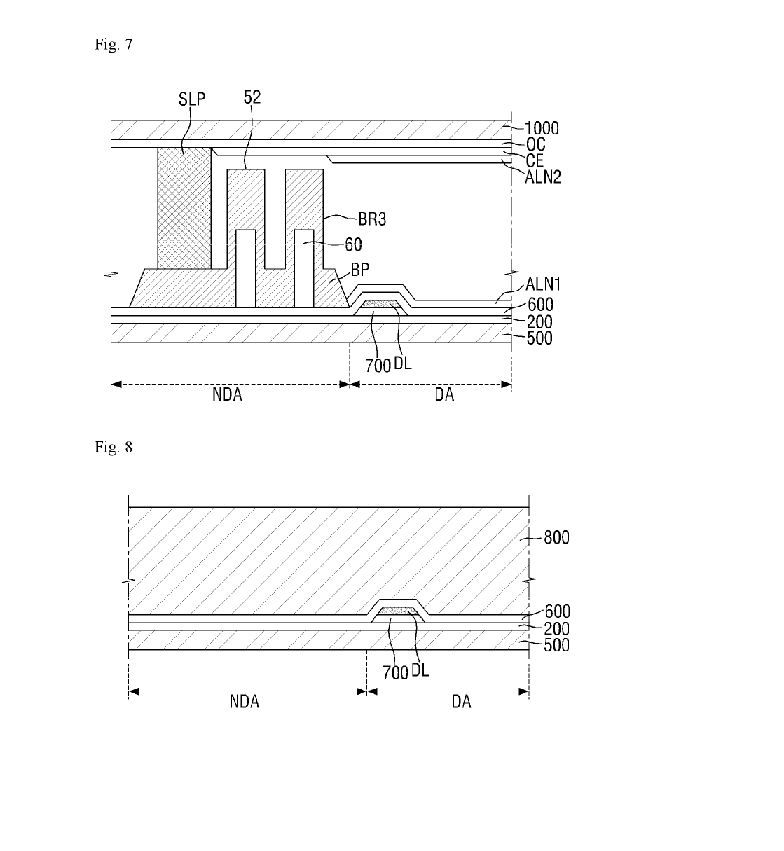

FIG. 7 is a cross-sectional view of an LCD according to another embodiment of the present inventive concept.

Referring to FIG. 7, the LCD according to the current embodiment is different from the LCD according to the embodiment of FIG. 5 in that it further includes dummy protruding patterns 60 in a non-display area NDA.

The dummy protruding patterns 60 may be disposed on a passivation layer 600. The dummy protruding patterns 60 may be made of substantially the same material as a color filter CF. That is, the color filter CF of the display area DA and the dummy protruding patterns 60 of the non-display area NDA may be formed substantially simultaneously in the same process. In an exemplary embodiment, the dummy protruding patterns 60 may be formed as blue color filters. When the dummy protruding patterns 60 are formed as blue color filters, they may secure a sufficient height such that alignment layer barrier patterns BR3, which will be described later, can secure a sufficient height.

A light-blocking pattern BP and the alignment layer barrier patterns BR3 may be disposed on the dummy protruding patterns 60 and cover the dummy protruding patterns 60. Specifically, when the light-blocking pattern BP covers the dummy protruding patterns 60, portions of the light-blocking pattern BP which overlap the dummy protruding patterns 60 may protrude relatively more than the other portions. Accordingly, the protruding portions may form the alignment layer barrier patterns BR3. In other words, the dummy protruding patterns 60 may support the alignment layer barrier patterns BR3 such that the alignment layer barrier patterns BR3 can secure a sufficient height.

Hereinafter, methods of manufacturing an LCD according to embodiments of the present inventive concept will be described. In the following embodiments, some elements may be identical to those of the LCDs according to the above-described embodiments of the present inventive concept, and thus a redundant description thereof will be omitted for the sake of simplicity.

FIGS. 8 through 10 are cross-sectional views illustrating a method of manufacturing an LCD according to an embodiment of the present inventive concept.

Referring to FIGS. 8 through 10, the method of manufacturing an LCD according to the current embodiment includes preparing a first substrate 500 which includes a gate insulating layer 200, a semiconductor pattern layer 700 disposed on the gate insulating layer 200, a data line DL disposed on the semiconductor pattern layer 700, a passivation layer 600 disposed on the data line DL and a light-blocking layer 800 disposed on the passivation layer 600 and in which a display area DA and a non-display area NDA are defined, forming a light-blocking pattern BP and a plurality of alignment layer barrier patterns BR1 which protrude from the light-blocking pattern BP in the non-display area NDA, and the black matrix BM (not shown) and the column spacer CS (not shown) on the display area DA by patterning the light-blocking layer 800, and forming a first alignment layer ALN1 in the display area DA.

Referring to FIG. 8, the gate insulating layer 200 may be formed on the first substrate 500. The gate insulating layer 200 may be formed using a method such as chemical vapor deposition (CVD).

Then, the semiconductor pattern layer 700 is formed on the gate insulating layer 200. The semiconductor pattern layer 700 may be formed using a method such as CVD.

The data line DL may be placed on the semiconductor pattern layer 700. That is, the data line DL may be placed to overlap the semiconductor pattern layer 700. However, in another exemplary embodiment, the semiconductor pattern layer 700 may not be formed under the data line DL.

The passivation layer 600 may be placed on the data line DL. The passivation layer 600 may contain an organic or inorganic insulating material. The passivation layer 600 may be formed using a method such as CVD.

The light-blocking layer 800 may be formed on the passivation layer 600. The light-blocking layer 800 may be made of photosensitive resin that contains a black pigment.

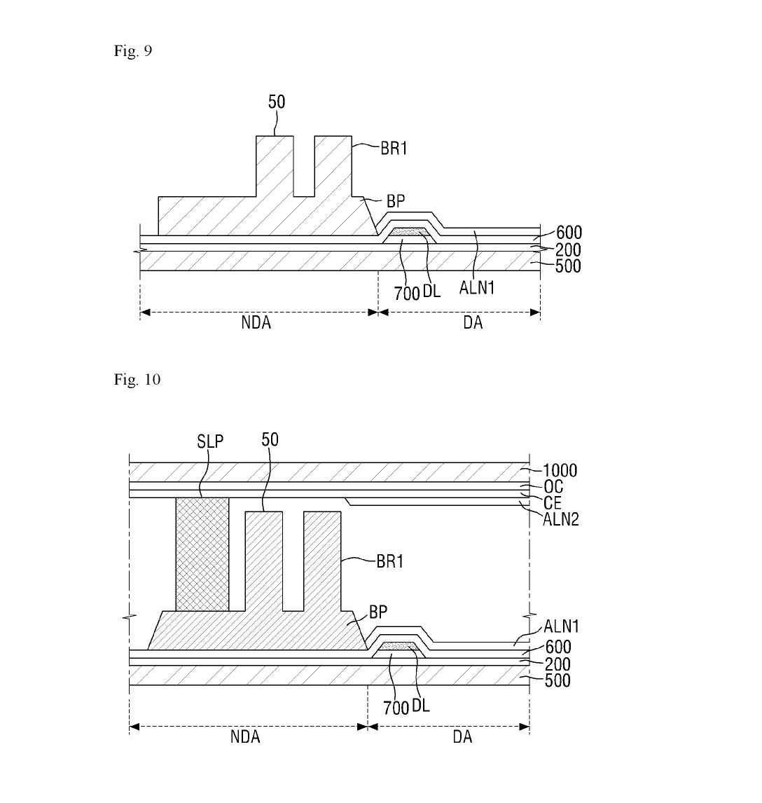

Referring to FIG. 9, the light-blocking pattern BP and the alignment layer barrier patterns BR1 which protrude from the light-blocking pattern BP in the non-display area NDA and the black matrix BM (not shown) and the column spacer CS (not shown) on the display area DA are simultaneously formed by patterning the light-blocking layer 800.

Upper ends of the alignment layer barrier patterns BR1 may be separated from each other. In addition, the upper ends of the alignment layer barrier patterns BR1 may be shaped like quadrilaterals and arranged in a matrix of columns and rows. Since this has been described above in detail with reference to FIGS. 4 and 6, a description thereof is omitted.

The light-blocking layer 800 in the display area DA may be patterned to form a black matrix BM (not shown) and a column spacer CS (not shown). That is, the method of manufacturing an LCD according to the current embodiment may be a method of manufacturing a BCS LCD.

That is, the black matrix BM and the column spacer CS in the display area DA may be made of substantially the same material as the light-blocking pattern BP and the alignment layer barrier patterns BR1 in the non-display area NDA and may be formed simultaneously in the same process.

Next, the first alignment layer ALN1 is formed in the display area DA. The first alignment layer ALN1 is designed to initially align a liquid crystal layer LC disposed between the first substrate 500 and a second substrate 1000. The first alignment layer ALN1 may contain a polymer material that undergoes one of decomposition, dimerization, and isomerization in response to light (e.g., UV light or laser light). In addition, the first alignment layer ALN1 may be made of a polymer polymerized with reactive mesogens.

Referring to FIG. 10, the method of manufacturing an LCD according to the current embodiment may further include placing the second substrate 100, which includes an overcoat layer OC, a common electrode CE and a second alignment layer ALN2, to face the first substrate 500 and encapsulating the first and second substrates 500 and 1000.

The overcoat layer OC may be placed on the second substrate 1000. The overcoat layer OC may be made of an organic material. The overcoat layer OC may be a known overcoat layer or an obvious combination of known overcoat layers, and thus a detailed description thereof is omitted.

The common electrode CE may be placed on the overcoat layer OC. The common electrode CE may be an unpatterned, whole-surface electrode. In an example, the common electrode CE may be made of a transparent conductor such as ITO or IZO or a reflective conductor such as aluminum.

The second alignment layer ALN2 may be placed on the common electrode CE. The second alignment layer ALN2 is designed to initially align the liquid crystal layer LC disposed between the first substrate 500 and the second substrate 1000. The second alignment layer ALN2 may contain a polymer material that undergoes one of decomposition, dimerization, and isomerization in response to light (e.g., UV light or laser light). In addition, the second alignment layer ALN2 may be made of a polymer polymerized with reactive mesogens.

Next, the first substrate 500 and the second substrate 100o are placed to face each other and then bonded together.

To this end, a seal pattern SLP for bonding the first and second substrates 500 and 1000 may be formed on the non-display area NDA of the first substrate 500. The seal pattern SLP may be substantially identical to those of the LCDs according to the above-described embodiments of the present inventive concept, and thus a detailed description thereof is omitted.

In a state where the first substrate 500 and the second substrate 1000 are paced to face each other, the first substrate 500 and the second substrate 1000 may be pressed against each other. Accordingly, the first substrate 500 and the second substrate 1000 may be bonded together by the seal pattern SLP. Here, the pressure with which the first and second substrates 500 and 1000 are pressed against each other can cause an alignment layer disposed in the display area DA to permeate into the seal pattern SLP of the non-display area NDA. However, if the alignment layer barrier patterns BR1 are formed in the non-display area NDA, the alignment layer of the display area DA can be prevented from permeating into the non-display area NDA in the encapsulation process.

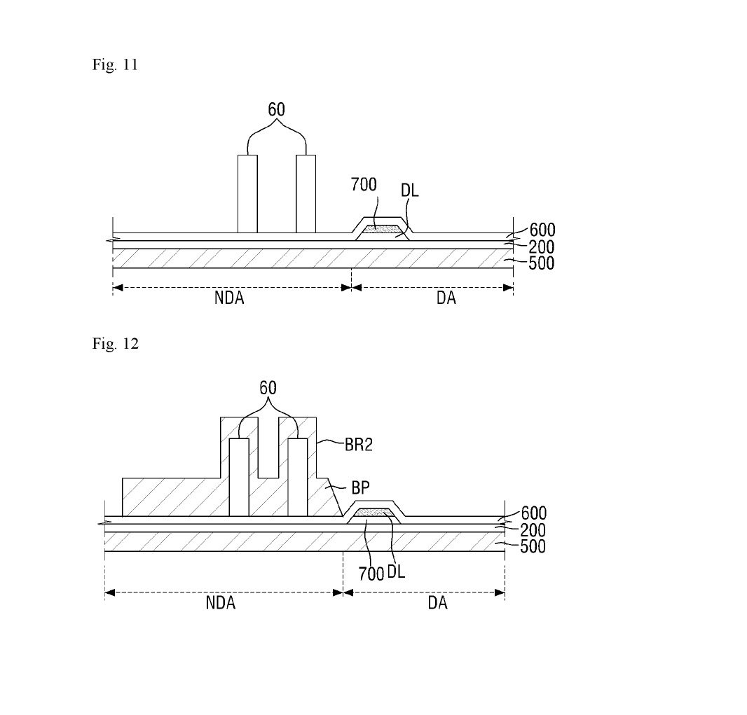

FIGS. 11 and 12 are cross-sectional views illustrating a method of manufacturing an LCD according to another embodiment of the present inventive concept.

Referring to FIGS. 11 and 12, the LCD according to the current embodiment is different from the method according to the embodiment of FIG. 8 in that dummy protruding patterns 60 are formed in a non-display area NDA.

The dummy protruding patterns 60 may be formed on a passivation layer 600 on a first substrate 500. The dummy protruding patterns 60 may be made of substantially the same material as a color filter CF of a display area DA. That is, the color filter CF of the display area DA and the dummy protruding patterns 60 of the non-display area NDA may be formed substantially simultaneously in the same process. In an exemplary embodiment, the dummy protruding patterns 60 may be formed as blue color filters. When the dummy protruding patterns 60 are formed as blue color filters, they may secure a sufficient height such that alignment layer barrier patterns BR3, which will be described later, can secure a sufficient height.

Referring to FIG. 12, a light-blocking pattern BP and the alignment layer barrier patterns BR3 may be placed on the dummy protruding patterns 60 to cover the dummy protruding patterns 60. Specifically, when the light-blocking pattern BP covers the dummy protruding patterns 60, portions of the light-blocking pattern BP which overlap the dummy protruding patterns 60 may protrude relatively more than the other portions. Accordingly, the protruding portions may form the alignment layer barrier patterns BR3. In other words, the dummy protruding patterns 60 may support the alignment layer barrier patterns BR3 such that the alignment layer barrier patterns BR3 can secure a sufficient height.

Embodiments of the present inventive concept provide at least one of the following advantages.

An LCD having a narrow bezel can be implemented.

An LCD having improved adhesion performance between an upper substrate and a lower substrate can be implemented.

However, the effects of the present inventive concept are not restricted to the one set forth herein. The above and other effects of the present inventive concept will become more apparent to one of daily skill in the art to which the present inventive concept pertains by referencing the claims.

While the present inventive concept has been particularly illustrated and described with reference to exemplary embodiments thereof, it will be understood by those of ordinary skill in the art that various changes in form and detail may be made therein without departing from the spirit and scope of the present inventive concept as defined by the following claims. The exemplary embodiments should be considered in a descriptive sense only and not for purposes of limitation.

What is claimed is:

1. A liquid crystal display (LCD) comprising:
a first substrate which comprises a display area and a non-display area disposed outside the display area;
a second substrate which is located opposite the first substrate;
a light-blocking pattern which is disposed on the non-display area; and
a plurality of alignment layer barrier patterns which protrude from the light-blocking pattern toward the second substrate and are formed integrally with the light-blocking pattern in the non-display area,
wherein an upper end of one alignment layer barrier pattern and an upper end of another adjacent alignment layer barrier pattern are separated from each other.

2. The LCD of claim 1, wherein the display area further comprises a black matrix and a column spacer which protrudes from the black matrix toward the second substrate.

3. The LCD of claim 2, wherein the black matrix and the column spacer are formed integrally with the light blocking pattern and the plurality of alignment layer barrier patterns in the non-display area.

4. The LCD of claim 1, wherein the upper ends of the alignment layer barrier patterns are separated from the second substrate.

5. The LCD of claim 1, further comprising a seal pattern disposed in the non-display area.

6. The LCD of claim 5, wherein the seal pattern overlaps the light-blocking pattern.

7. The LCD of claim 1, wherein the upper ends of the alignment layer barrier patterns are shaped like quadrilaterals.

8. The LCD of claim 1, wherein the upper ends of the alignment layer barrier patterns are arranged in a matrix of columns and rows.

9. The LCD of claim 1, wherein the upper ends of the alignment layer barrier patterns are shaped like bars extending in a direction perpendicular to an x axis, and the upper ends of the alignment layer barrier patterns disposed in a first column are arranged alternately with the upper ends of the alignment layer barrier patterns disposed in a second column.

10. The LCD of claim 1, further comprising dummy protruding patterns disposed in the non-display area, wherein the light-blocking pattern and the alignment layer barrier patterns cover the dummy protruding patterns.

11. The LCD of claim 10, wherein the dummy protruding patterns are made of the same material as a color filter in the display area.

12. The LCD of claim 11, wherein the color filter comprises a blue color filter, a red color filter and a green color filter, and the dummy protruding patterns are made of the same material as the blue color filter.

13. The LCD of claim 1, further comprising:
a first alignment layer which is disposed on the first substrate; and
a second alignment layer which is disposed on the second substrate,
wherein the first alignment layer and the second alignment layer are located opposite each other.

14. A method of manufacturing an LCD, the method comprising:
preparing a first substrate which comprises a gate insulating layer, a semiconductor pattern layer disposed on the gate insulating layer, a data line disposed on the semiconductor pattern layer, a passivation layer disposed on the data line and a light-blocking layer disposed on the passivation layer and in which a display area and a non-display area disposed outside the display area are defined;
forming a light-blocking pattern and a plurality of alignment layer barrier patterns, which protrude from the light-blocking pattern, in the non-display area by patterning the light-blocking layer; and
forming a first alignment layer in the display area.

15. The method of claim 14, further comprising placing a second substrate, which comprises an overcoat layer, a common electrode disposed on the overcoat layer and a second alignment layer disposed on the common electrode, to face the first substrate and encapsulating the first and second substrates.

16. The method of claim 15, further comprising forming dummy protruding patterns in the non-display area, wherein the dummy protruding patterns are made of the same material as a color filter.

17. The method of claim 14, further comprising forming dummy protruding patterns in the non-display area,
wherein the forming of the light-blocking pattern and the alignment layer barrier patterns comprises forming the light-blocking pattern and the alignment layer barrier patterns on the dummy protruding patterns to cover the dummy protruding patterns.

18. The method of claim 14, wherein upper ends of the alignment layer barrier patterns are separated from each other and arranged in a matrix of columns and rows.

19. The method of claim 14, further comprises forming a black matrix and a column spacer on the display area,
wherein the black matrix and the column spacer are formed of a same material on the same plane as the light blocking pattern and the plurality of alignment layer barrier patterns.

20. The method of claim 19, further comprising forming dummy protruding patterns in the non-display area, the dummy protruding patters being formed of a same material as a color filter in the display area.
